(19) United States
(12) Patent Application Publication
(10) Pub. No.: US 2017/0105010 A1
(43) Pub. Date: Apr. 13, 2017

(54) RECEIVER-SIDE MODIFICATIONS FOR REDUCED VIDEO LATENCY

(71) Applicant: Microsoft Technology Licensing, LLC, Redmond, WA (US)

(72) Inventors: Yongjun Wu, Bellevue, WA (US); Sudhakar Prabhu, Redmond, WA (US); Carol Greenbaum, Seattle, WA (US); Saswata Mandal, Bellevue, WA (US); Shyam Sadhwani, Bellevue, WA (US)

(21) Appl. No.: 14/879,106

(22) Filed: Oct. 9, 2015

(51) Int. Cl. H04N 19/174; H04N 21/854; H04N 19/70; H04N 21/426; H04N 21/845; H04N 21/2662; H04N 21/434; H04N 19/436; H04N 19/31

(52) U.S. Cl. CPC H04N 19/174; H04N 19/436; H04N 21/85406; H04N 19/70; H04N 19/31; H04N 21/8451; H04N 21/2662; H04N 21/4343; H04N 21/4341; H04N 21/42615

(57) ABSTRACT

A host has a graphics pipeline that process frames by portions (e.g., pixels or rows) or slices. A remote device transmits a video stream container via a network to the host. A frame of the video stream in the container has encoded portions. The graphics pipeline includes a demultiplexer that extracts the portions of the video frame. When a portion has been extracted it is passed to a decoder, which is next in the pipeline. The decoder may begin decoding the portion before receiving a next portion of the frame, possibly while the demultiplexer is demultiplexing the next portion of the frame. A decoded portion of the frame is passed to a renderer which accumulates the portions of the frame and renders the frame. At any time portions of a frame might concurrently be being received, demultiplexed, decoded, and rendered. The decoder may be single-threaded, multi-threaded, or hardware accelerated.

### RELATED APPLICATIONS

This application is related to U.S. patent application Ser. No. 14/842,823 (attorney docket 357779.01), filed Sep. 1, 2015, titled “PARALLEL PROCESSING OF A VIDEO FRAME”; and Ser. No. 14/795,861 (attorney docket 357780.01), filed Jul. 9, 2015, and titled “INTRA-REFRESH FOR VIDEO STREAMING”.

### BACKGROUND

Computing devices that generate and encode video have been constructed with a pipeline architecture where components cooperate to concurrently perform operations on different video frames. The components typically include a video generating component, a framebuffer, an encoder, and possibly some other components that might multiplex sound data, prepare video frames for network transmission, perform graphics transforms, etc. Typically, the unit of data dealt with by a graphics pipeline has been the video frame. That is, a complete frame fills a framebuffer, then the complete frame is passed to a next component, which may transform the frame and only pass the transformed frame to a next component when the entire frame has been fully transformed.

This frame-by-frame approach may be convenient for the design of hardware and of software to drive the hardware. For example, components of a pipeline can all be driven by the same vsync (vertical sync) signal. However, there can be disadvantages in scenarios that require real-time responsiveness and low latency. As observed only by the instant inventors, the latency from (i) the occurrence of an event that causes graphics (video frames) to start being generated at one device to (ii) the time at which the graphics is displayed at another device, can be long enough to be noticeable. Where the event is a user input to an interactive graphics-generating application such as a game, this latency can cause the application to seem unresponsive or laggy to the user. As only the inventors have appreciated, the time of waiting for a framebuffer to fill with a new frame before the rest of a graphics pipeline can process (e.g., start encoding) the new frame, and the time of waiting for a whole frame to be encoded before a network connection can start video streaming, can contribute to the overall latency.

In addition to the foregoing, to encode video for streaming over a network or a wireless channel, it has become possible to perform different types of encoding on different slices of a same video frame. For example, the ITU's (International Telecommunication Union) H.264/AVC and HEVC/H.265 standards allow for a frame to have some slices that are independently encoded (“ISlices”). An ISlice has no dependency on other parts of the frame or on parts of other frames. The H.264/AVC and HEVC/H.265 standards also allow slices (“PSlices”) of a frame to be encoded based on other slices of a preceding frame with inter-frame prediction and compensation. Such slices can also be independently decoded.

When a stream of frames encoded in slices is transmitted on a lossy channel, if an individual Nth slice of one frame is corrupted or dropped, it is possible to recover from that partial loss by encoding the Nth slice of the next frame as an ISlice. However, when an entire frame is dropped or corrupted, a full encoding recovery becomes necessary. Previously, such a recovery would be performed by transmitting an entire Iframe (as used herein, an “Iframe” will refer to either a frame that has only ISlices or a frame encoded without slices, and a “Pframe” will refer to a frame with all PSlices or a frame encoded without any intra-frame encoding). However, as observed only by the present inventors, the transmission of an Iframe can cause a spike in frame size relative to Pframes or frames that have mostly PSlices. This spike can create latency problems, jitter, or other artifacts that can be problematic, in particular for interactive applications such as games.

Described below are techniques related to, among other things, implementing a graphics pipeline capable of processing (e.g., decoding) an inbound video frame by slices thereof and possibly before the video frame has been fully received from a device that encoded and transmitted the video frame.

### SUMMARY

The following summary is included only to introduce some concepts discussed in the Detailed Description below. This summary is not comprehensive and is not intended to delineate the scope of the claimed subject matter, which is set forth by the claims presented at the end.

A host has a graphics pipeline that process frames by portions (e.g., pixels or rows) or slices. A remote device transmits a video stream container via a network to the host. A frame of the video stream in the container has encoded portions. The graphics pipeline includes a demultiplexer that extracts the portions of the video frame. When a portion has been extracted it is passed to a decoder, which is next in the pipeline. The decoder may begin decoding the portion before receiving a next portion of the frame, possibly while the demultiplexer is demultiplexing the next portion of the frame. A decoded portion of the frame is passed to a renderer which accumulates the portions of the frame and renders the frame. At any time portions of a frame might concurrently be being received, demultiplexed, decoded, and rendered. The decoder may be single-threaded, multi-threaded, or hardware accelerated.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a host transmitting a video stream to a client.

FIG. 2 shows a timeline of processing by a frame-by-frame pipeline architecture.

FIG. 3 shows a timeline where video frames are processed in incremental portions.

FIG. 4 shows how a framebuffer, an encoder, and a transmitter/multiplexer (Tx/mux) can be configured to process portions of frames concurrently.

FIG. 5 shows a sequence of encoded video frames transmitted from the host to the client.

FIG. 6 shows how a video stream can be recovered when a Pframe becomes unavailable for decoding.

FIG. 7 shows a process for performing an intra-refresh when encoded video data is unavailable.

FIG. 8 shows how a client graphics pipeline can be configured to process portions of frames concurrently, possibly even before a video frame is completely received.

FIG. 9 shows a client with a software-based multi-threaded decoder.

FIG. 10 shows an example of a computing device.

Many of the attendant features will be explained below with reference to the following detailed description considered in connection with the accompanying drawings.

### DETAILED DESCRIPTION

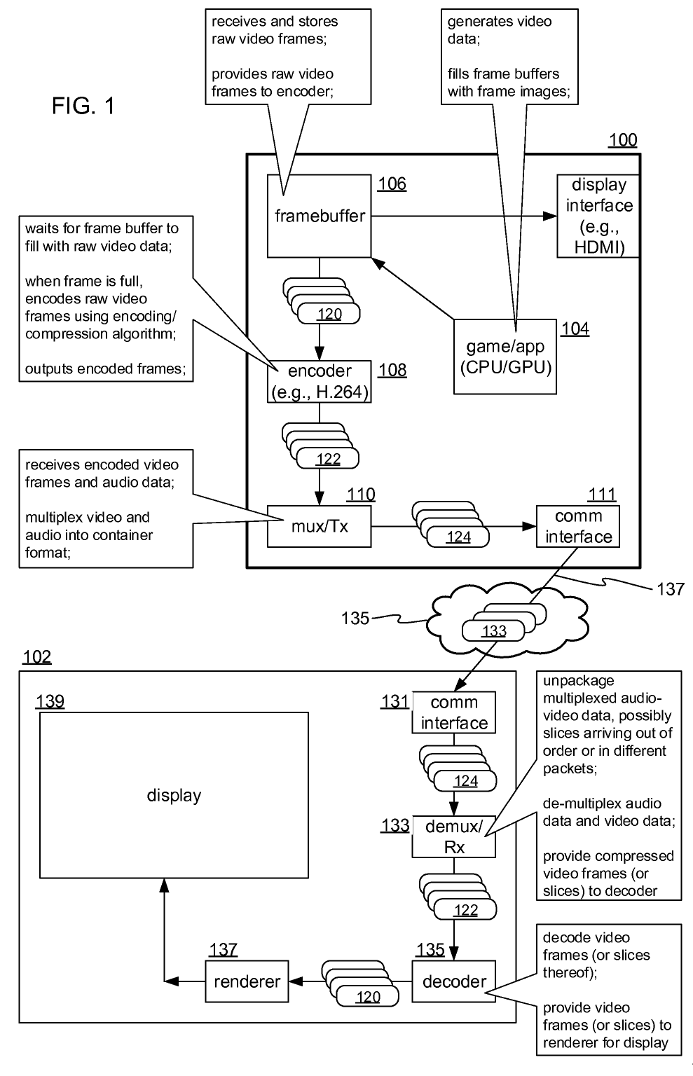

FIG. 1 shows a host 100 transmitting a video stream to a client 102. The host 100 and client 102 may be any type of computing devices. An application 104 is executing on the host 100. The application 104 can be any code that generates video data, and possibly audio data. The application 104 will generally not execute in kernel mode, although this is possible. The application 104 has logic that generates graphic data in the form of a video stream (a sequence of 2D frame images). For instance, the application 104 might have logic that interfaces with a 3D graphics engine to perform 3D animation which is rendered as 2D images. The application 104 might instead be a windowing application, a user interface, or any other application that outputs a video stream.

The application 104 is executed by a central processing unit (CPU) and/or a graphics processing unit (GPU), perhaps working in combination, to generate individual video frames. These raw video frames (e.g., RGB data) are written to a framebuffer 106. While in practice the framebuffer 106 may be multiple buffers (e.g., a front buffer and a back buffer), for discussion, the framebuffer 106 will stand for any type of buffer arrangement, including a single buffer, a triple buffer, etc. As will be described, the framebuffer 106, an encoder 108, and a transmitter/multiplexer (Tx/mux) 108 work together, with various forms of synchronization, to stream the video data generated by the application 104 to the client 102.

The encoder 108 may be any type of hardware and/or software encoder or hybrid encoder configured to implement a video encoding algorithm (e.g., H.264 variants, or others) with the primary purpose of compressing video data. Typically, a combination of inter-frame and intra-frame encoding will be used.

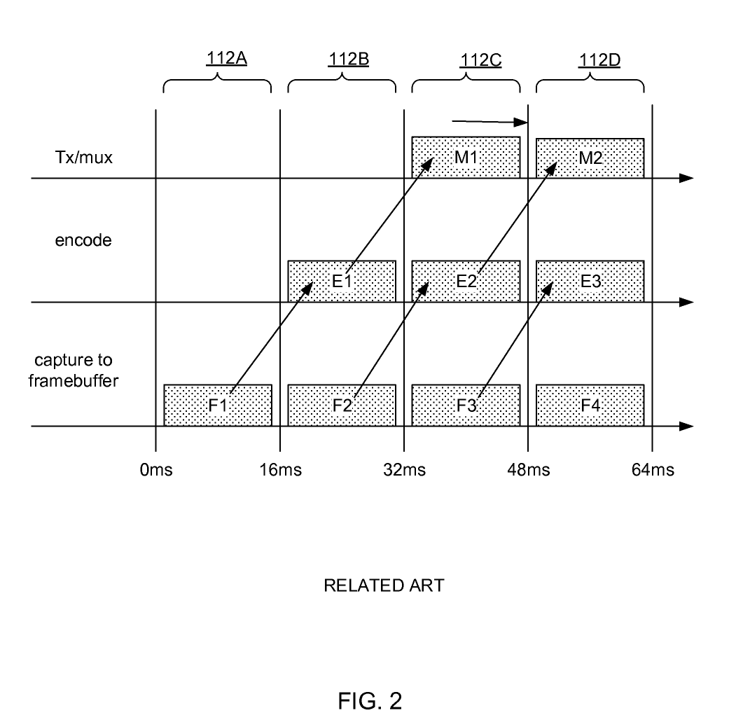

The Tx/mux 108 may be any combination of hardware and/or software that combines encoded video data and audio data into a container, preferably of a type that supports streaming. The following are examples of suitable formats AVI (Audio Video Interleaved), FLV (Flash Video), MKV (Matroska), MPEG-2 Transport Stream, MP4, etc. The Tx/mux 108 may interleave video and audio data and attach metadata such as timestamps, PTS/DTS durations, or other information about the stream such as a type or resolution. The containerized (formatted) media stream is then transmitted by various communication components of the host 100. For example, a network stack may place chunks of the media stream in network/transport packets, which in turn may be put in link/media frames that are physically transmitted by a communication interface 111. In one embodiment, the communication interface 111 is a wireless interface of any type. As will be explained with reference to FIG. 2, in previous devices, the type of pipeline generally represented in FIG. 1 would operate on a frame-by-frame basis. That is, frames were processed as discrete units during respective discrete cycles. Although the devices in FIG. 1 have similarities to such prior devices, they also differ from prior devices in ways that will be described herein.

FIG. 2 shows a timeline of processing by a frame-by-frame pipeline architecture. With prior graphics generating devices, a refresh signal that corresponds to a display refresh rate drives the graphics pipeline. For example, for a 60 Hz refresh rate, a vsync (vertical-sync) signal is generated for every 16 ms refresh cycle 112 (112A-112D refer to individual cycles). Each refresh cycle 112 is started by a vsync signal and begins a new increment of parallel processing by each of (i) the capturing hardware that captures to the framebuffer 106, (ii) the encoder 108, and (iii) the Tx/mux 110. In FIG. 2, it is assumed that a new video stream is starting, for example, in response to a user input. As will be explained, a graphics pipeline corresponding to the example of FIG. 2 requires two refresh cycles 112 before the corresponding video stream can begin transmitting to the client 102.

At the beginning of the first refresh cycle 112A after the user input, each component of the graphics pipeline is empty or idle. During the first refresh cycle 112A, the framebuffer 106 fills with the first frame (F1) of raw video data. During the second refresh cycle 112B, the encoder 108 begins encoding the frame F1 (forming encoded frame E1), while at the same time the framebuffer 106 begins filling with the second frame (F2), and the Tx/mux 110 remains idle. During the third refresh cycle 112C, each of the components is busy: the Tx/mux 110 begins to process the encoded frame E1 (encoded F1, forming container frame M1), the encoder 108 encodes frame F2 (forming a second encoded frame E2), and the framebuffer 106 fills with a third frame (F3). The fourth refresh cycle 112D and subsequent cycles continue in this manner until the framebuffer 106 is empty. This is assumes that the encoder takes 16 ms to encode a frame. However, if the encoder is capable to encoding faster, the Tx/mux can start as soon as the encoder is finished. Due to power considerations, the encoder can be typically run so that it can encode a frame in 1 vsync period.

It is apparent that a device configured to operate as shown in FIG. 2 has an inherent latency of approximately two refresh cycles between the initiation of video generation (e.g., by a user input or other triggering event) and the transmission of the video. For some applications such as interactive games, this delay to prime the graphics pipeline can be noticeable and the experience of the user may not be ideal. As will be explained with reference to FIGS. 1, 3, and 4, this latency can be significantly reduced by configuring the host 100 to process frames in piecewise fashion where portions of a same frame are processed in parallel at different stages of the pipeline.

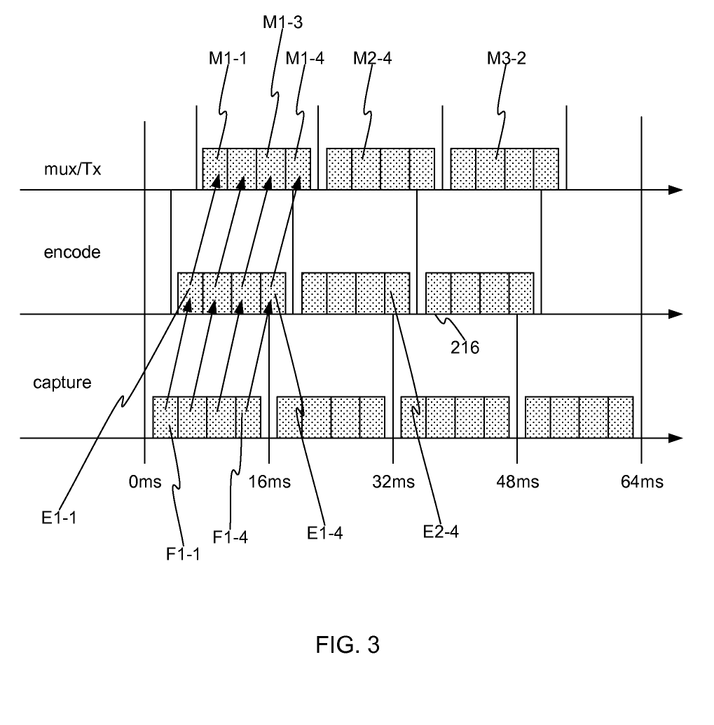

FIG. 3 shows a timeline where video frames are processed in incremental portions. In the example of FIG. 3, each frame has 4 portions (N=4). However, any number greater than two may be used for N, with the consideration that larger values of N may decrease the latency but the video fidelity and/or coding rate may be impacted due to smaller portions being encoded. The frames in FIG. 3 will be referred to with similar labels as in FIG. 2, but with a sub-index number added. For example, the first unencoded frame F1 has four portions that will be referred to as F1-1, F1-2, F1-3, and F1-4. Similarly, the first encoded frame, for example, has portions E1-1 through E1-4, and the first Tx/mux frame has container portions M1-1 to M1-4.

FIG. 1 shows unencoded frame portions 120 passing from the framebuffer 106 to the encoder 108. FIG. 1 also shows encoded frame portions 122 passing from the encoder 108 to the Tx/mux 110. FIG. 1 further shows container portions outputted by the Tx/mux 110 for transmission by the communication facilities (e.g., network stack and communication interface 111) of the host 100. The frame portions 120 may be any of the frame portions FX-Y (e.g., F1-1) shown in FIG. 3. The encoded portions 122 may be any of the encoded portions EX-Y (e.g., E2-4), and the container portions 124 may be any of the container portions MX-Y (e.g., M1-3).

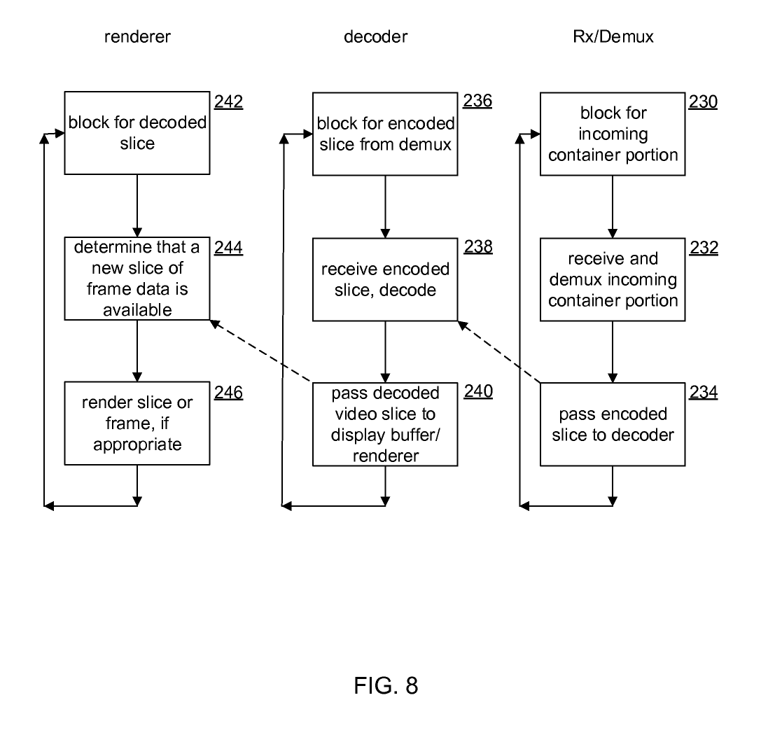

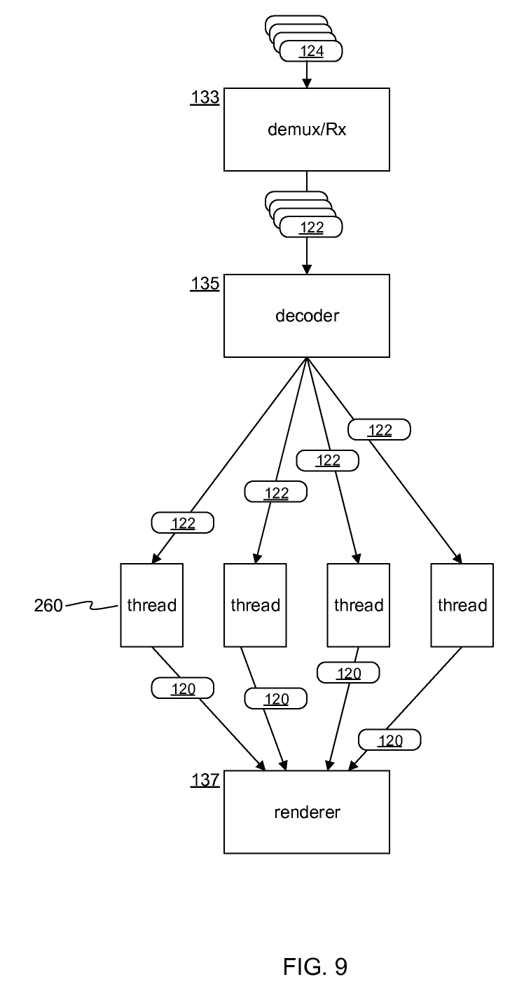

The client 102 has a communication interface 131 that receives packets 133 over a network 135 via a network connection 137 with the interface 111 of the host 100. The payloads of the packets 133 carry container portions 124 (chunks of the video package/stream). The client 102 assembles the payloads of the packets 133 to reform the container portions 124. A demultiplexer 133 at the client 102 demultiplexes the media within the container portions 124 to obtain encoded frame portions 122 (i.e., encoded video frame slices), which are described later. The client's 102 graphics pipeline also includes a decoder 135, which decodes the encoded frame portions 122 and outputs unencoded frame portions 120 to a renderer 137 which renders the decoded video data to a display 139. Embodiments and other details of receiving devices are described below with reference to FIGS. 8 and 9.

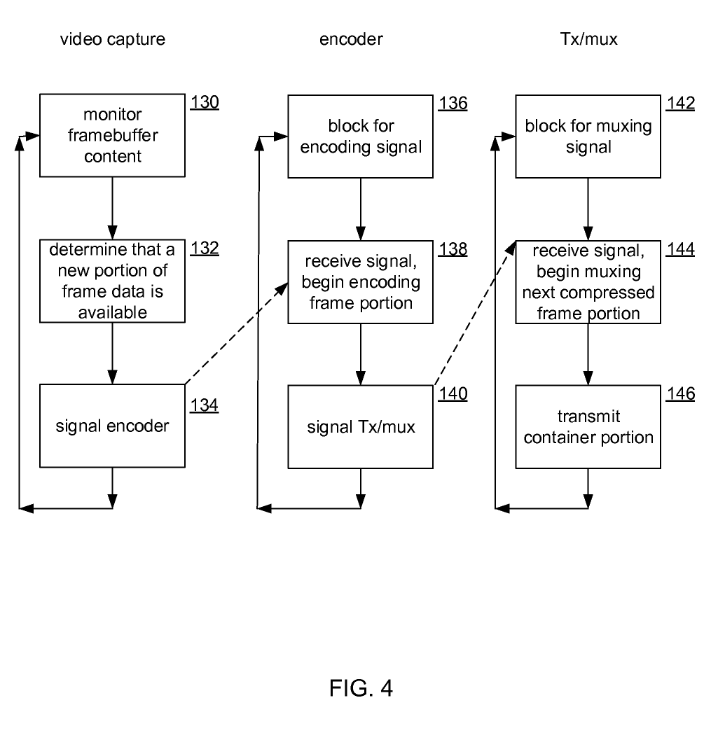

FIG. 4 shows how the framebuffer 106, the encoder 108, and the Tx/mux 110 can be configured to process portions of frames concurrently, possibly even before a video frame is completely generated and fills the framebuffer 106. Initially, as in FIG. 2, the application 104 begins to generate video data, which starts to fill the framebuffer 106. At step 130, the video capture hardware is monitoring the framebuffer 106. At step 132 the video capture hardware determines that the framebuffer 106 contains a new complete portion of video data, and, at step 134, signals the encoder 108.

At step 136 the encoder 108 is blocked (waiting) for a portion of a video frame. At step 138 the encoder 108 receives the signal that a new frame portion 120 is available. In this example, the first frame portion will be frame F1-1. At step 140 the encoder 108 signals the Tx/mux 110 that an encoded portion 122 is available. In this case, the first encoded portion is encoded portion E1-1 (the encoded form of frame portion F1-1).

At step 142 the Tx/mux 110 is block-waiting for a signal that data is available. At step 144 the Tx/mux 110 receives the signal that encoded portion E1-1 is available, copies or accesses the new encoded portion, and in turn the Tx/mux 110 multiplexes the encoded portion E1-1 with any corresponding audio data. The Tx/mux 110 outputs the container portion 124 (e.g., M1-1) for transmission to the client 102.

It should be noted that the aforementioned components operate in parallel. When the capture hardware has finished a cycle at step 134 the capture hardware continues at step 130 to check for new video data while the encoder 108 operates on the output from the framebuffer 106 and while the Tx/mux 110 operates on the output from the encoder 108. Similarly, when the encoder 108 has finished encoding one frame portion it begins a next, and when the Tx/mux 110 has finished one encoded portion it begins a next one, if available.

As can be seen in FIG. 3, by reducing the granularity of processing from frames to portions of frames, it is possible to reduce the latency between the initiation of video generation and the transmission of the appropriately processed generated video. Synchronization between the pipeline components can be accomplished in a variety of ways. As described above, each component can generate a signal for the next component. Timers can be used to assure that each component does not create a conflict by failing to finish processing a portion in sufficient time. For example, if frames are partitioned into four portions, and the refresh cycle is 16 ms, then each component might have a 4 ms timer. In practice, the time will be a small amount less to allow for overhead such as interrupt handling, data transfer, and the like. In another embodiment, the graphics pipeline is driven by the vsync signal and each component has an interrupt or timer appropriately offset from the vsync signal (e.g., ˜4 ms). Different components can generate interrupts as a mechanism to notify the next component in pipeline that the data is ready for their consumption. Any combination of driver signals, timers, and inter-component signals, implemented either in hardware, firmware, or drivers, can be used to synchronize the pipeline components.

Details about how video frames can be encoded by portions or slices are available elsewhere; many video encoding standards, such as the H.264 standard, specify features for piece-wise encoding. However, embodiments will work even if video standard does not have concept of slices, or encoder is configured to use single slice encoding. An encoder can be limited to the portion of video available for motion search. That is, while encoding E1-1, the encoder will limit access of the motion search to only the E1-1 portion. In addition, the client 102 need not be modified in order to process the video stream received from the host 100. The client 102 receives an ordinary containerized stream. An ordinary decoder at the client 102 can recognize the encoded units (portions) and decode accordingly. In one embodiment, the client 102 can be configured to decode in portions, which might marginally decrease the time needed to begin displaying new video data received from the host 100.

In a related aspect, latency or throughput can be improved in another way. Most encoding algorithms create some form of dependency between encoded frames. For example, as is well understood, time-variant information, such as motion, can be detected across frames and used for compression. Even in the case where a frame is encoded in portions, as described above, some of those portions will have dependencies on previous portions. The embodiments described above can end up transmitting individual portions of frames in different frames or packets. A noisy channel that causes intermittent packet loss or corruption can create problems because loss/corruption of a portion of a frame can cause the effective loss of the entire frame or a portion thereof. Moreover, a next Pframe/Bframe (predicted frame) may not be decodable without the good reference. For convenience, wherever the terms “Pframe” and “PSlice” are used herein, such terms are intended to represent predictively encoded frames/slices, or bi-directionally predicted frames/slices (Bframes/Bslices), or both. In other words, where the context permits, “PFrame” refers to “Pframe and/or Bframe”, and “PSlice” refers to “PSlice and/or Bslice”. Described next are techniques to refresh (allow decoding to resume) a disrupted encoded video stream without requiring transmission of a full Iframe (intracoded frame).

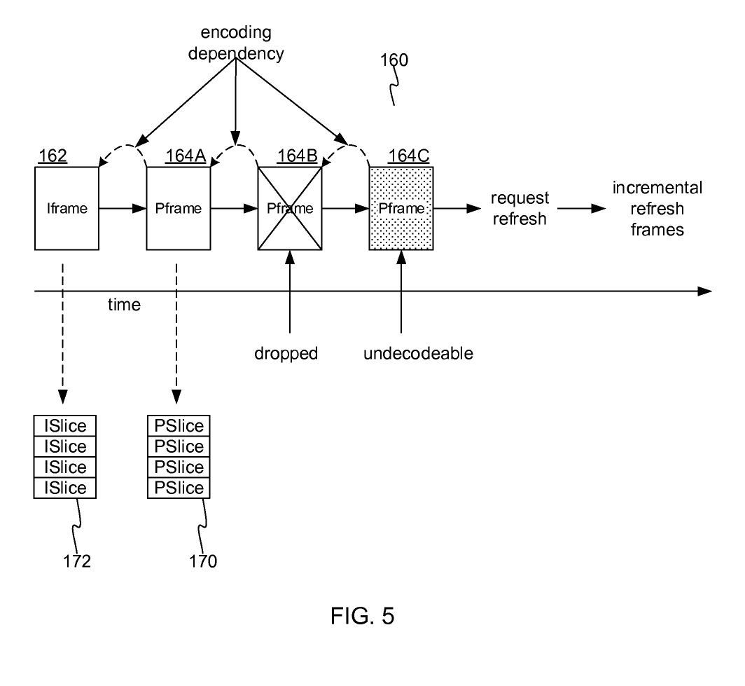

FIG. 5 shows a sequence 160 of encoded video frames transmitted from the host 100 to the client 102. As is known in the art of video encoding, frames can be encoded based on changes between frames (Pframes 164A-164C) or based only on the intrinsic content of one frame ((frames 162). An Iframe can be decoded without needing other frames, but Iframes are large relative to Pframes and Bframes. Pframes, on the other hand, depend on and require other frames to be decoded cleanly. As shown in FIG. 5, when Pframe 164B is not available for decoding, perhaps due to packet loss or corruption during transmission, the next Pframe 164C cannot be decoded. Prior approaches would require a new Iframe each time a Pframe was effectively not available for decoding. Embodiments described next allow an encoded video stream to be recovered with low latency and with near-certainty and reasonable fidelity.

As is also known and discussed above, many video encoding algorithms and standards include features that allow slice-wise encoding. That is, a video frame can have intra-encoded (self-decodable data) portions or slices, as well as predictively encoded portions or slices. The former are often referred to as ISlices, and the latter are often referred to as PSlices. As shown in FIG. 5, a Pframe can be encoded as set of PSlices 170, and an Iframe can be encoded as a set of ISlices 172. It is also possible for an encoded frame to have a mix of ISlices 172 and PSlices 170, with the PSlices of one frame being dependent on PSlices and/or ISlices of the previous frame. Slice-based encoding can be helpful for a pipeline that works with portions of frames rather than whole frames, as described above. In addition, smaller pieces of encoded data such as PSlices and ISlices can be individually transmitted across a wireless link or other potentially lossy medium, which can help with data retransmission. If a slice is unavailable for decoding, only that slice might need to be retransmitted in order to recover. Nonetheless, in some situations, an entire frame might be unavailable for decoding.

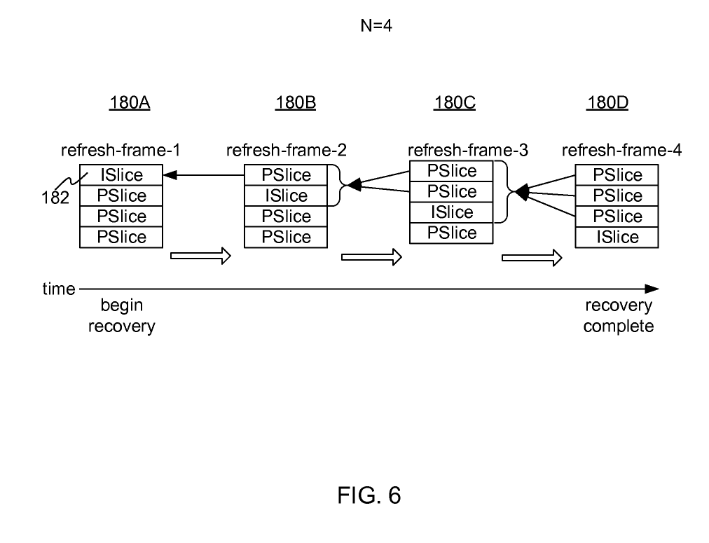

FIG. 6 shows how a video stream can be recovered when a Pframe becomes unavailable due to packet loss, corruption, misordering, etc. When the client 102 provides feedback to the host 100 that a frame has been corrupted or lost, the host 100 transmits a sequence of frames that together include sufficient ISlices to refresh the video stream. Supposing that Pframe 164B has been dropped, a first refresh-frame 180A is encoded with a corresponding ISlice 182 and a remainder of PSlices br. A next refresh-frame, second refresh-frame 1808, is then encoded with a second ISlice in the next slice position. The third refresh-frame 180C is similarly encoded with an ISlice at the next slice position (the third slice position). The fourth refresh-frame 180D is encoded with an ISlice at the fourth and last slice position (partitions other than four slices may be used).

The other slices of each refresh-frame are encoded as PSlices. However, because only portions of a previous refresh-frame may be valid, the encoding of any given PSlice may involve restrictions on the spatial scope of scans of the previous frame. That is, scans for predictive encoding are limited to those portions of the previous frame that contain valid encoded slices (whether PSlices or ISlices). In one embodiment where the encoding algorithm uses a motion vector search for motion-based encoding, the motion vector search is restricted to the area of the previous refresh-frame that is valid (i.e., the intra-refreshed portion of the previous frame). In the case of the second refresh-frame 1808, predictive encoding is limited to only the ISlice of the first refresh-frame 180A. In the case of the third refresh-frame 180C, predictive encoding is limited to the first two slices of the second refresh-frame 1808 (a PSlice and an ISlice). For the fourth refresh-frame 180D, predictive encoding is performed over all but the last slice of the third refresh-frame 180C. After the fourth refresh-frame 180D, the video stream has been refreshed such that the current frame is a complete validly encoded frame and encoding with mostly Pframes may resume.

While different patterns of ISlice positions may be used over a sequence of refresh-frames, the staggered approach depicted in FIG. 6 may be preferable because it provides a contiguous searchable frame area that increases in size with each refresh-frame; the first refresh-frame has a one-slice searchable area, the next has a two-slice searchable area, and so forth. Moreover, the searchable area grows with the addition of predictively encoded slices (PSlices) and therefore is encoded with a minimal amount of intra-encoded data in any given intra-refresh frame.

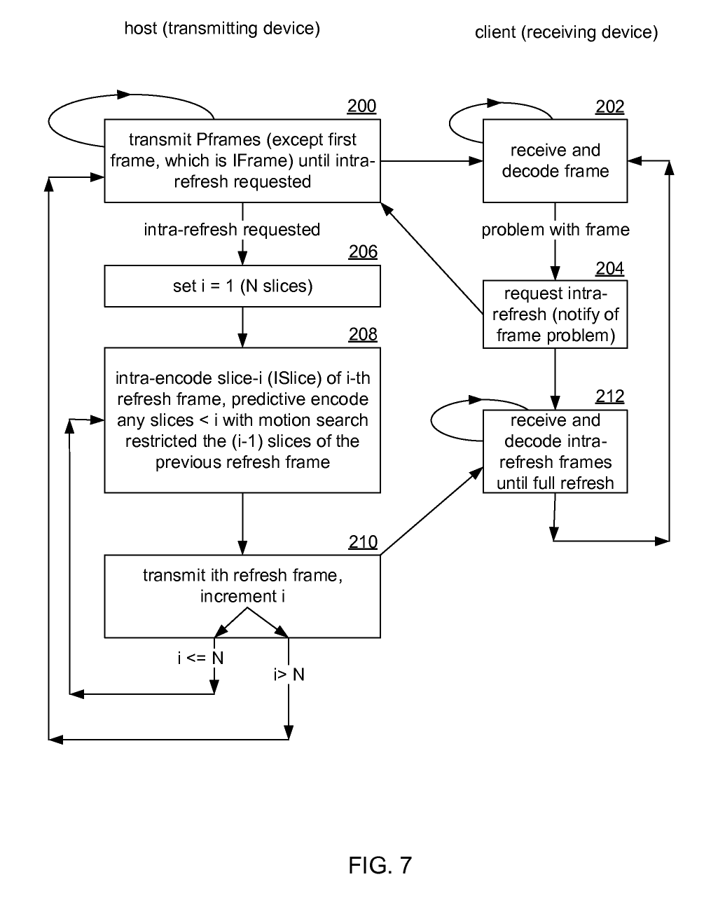

FIG. 7 shows a process for performing an intra-refresh when encoded video data is unavailable. At step 200, the host 100 is transmitting primarily Pframes, each dependent on the previous for decoding. At step 202, the client 102 receives the Pframes and decodes them using the previous Pframes. While receiving the Pframes, the client 102 detects a problem with a Pframe (e.g., missing, corrupt, out of sequence, etc.). Missing encoded data can be detected at the network layer, at the encoding layer, at the decoding layer or any combination of these. In response to the missing Pframe, at step 204 the client 102 transmits a message to the host 100 indicating which frame was not able to be decoded by the client 102. At step 206 the host 100 begins sending intra-refresh frames. A loop can be used to incrementally shift the slice to be intra-encoded (encoded as an ISlice) down after each frame. At step 208, the current intra-refresh frame is encoded. For the i-th refresh-frame, the i-th slice is encoded as an ISlice. The slices above the i-th slice (if any) are predictively encoded as PSlices. Moreover, when encoding any PSlices, the predictive scanning for those PSlices (in particular, a search for a motion vector) is limited in scope to the refreshed portion of the previous frame (an ISlice and any PSlices above it). After an i-th refresh-frame has been encoded it is transmitted at step 210 and the iteration variable i is incremented until a refresh-frame with N (e.g., four) valid slices has been transmitted, such as the fourth refresh-frame 180D shown in FIG. 6.

As the refresh-frames are transmitted, at step 212 the client receives the refresh-frames and decodes them in sequence until a fully valid frame has been reconstructed, at which time the client 102 resumes receiving and decoding primarily ordinary Pframes at step 202.

In some implementations, the use of slices that are aligned from frame to frame can create striations artifacts; seams may appear at slice boundaries. This effect can be reduced with several techniques. Dithering with randomization of the intra-refresh slices can be used for smoothening. Put another way, instead of using ISlices, an encoder may encode different blocks as intra blocks in a picture. The spatial location of these blocks can be randomized to provide a better experience. To elaborate on the dithering technique, the idea is that, instead of encoding I-macroblocks consecutively upon a transmission error or the like, spread out the I-macroblocks across the relevant slice. This can help avoid the decoded image appearing to fill from top to bottom. Instead, with dithering, it will appear that the whole frame is getting refreshed. To the viewer it may look like the image is recovered faster.

To optimize performance, conditions of the channel between the host 100 and the client 102 can be used to inform the intra-refresh encoding process. Parameters of intra-refresh encoding can be targeted to appropriately fit the channel or to take into account conditions on the channel such as noise, packet loss, etc. For instance, the compressed size of ISlices can be targeted according to estimated available channel bandwidth. Slice QP (quantization parameter), and MB (macro-block) delta can be adjusted adaptively to meet the estimated target.

FIG. 8 shows how the framebuffer demultiplexer 133, the decoder 135, and the renderer 137 can be configured to process portions of frames concurrently, possibly even before a video frame is completely received. Once the transmitting host 102 has begun to transmit packets 133, the client 102 begins receiving same. The client's network stack assembles the packets, extracts the container portions 124 and passes them to the demultiplexer 133, which is blocked at step 230. In response, at step 232 the demultiplexer 133 unblocks, receives the incoming container portion, and demultiplexes the container portion to produce an encoded frame portion 122. At step 236, the decoder 135 is blocked while waiting for a frame portion to process. At step 238 the decoder unblocks to receive the encoded frame portion, and at step 238 decodes same, and provides the decoded video slice 120 to the renderer 137. The renderer accumulates decoded video slices and displays frames accordingly.

As with the graphics pipeline of the transmitting host 100, the components of the graphics pipeline of the client 102 operate in parallel. At any time, portions of video data of a frame can be concurrently processed at different stages.

The transmitting host 100 may be expected to stream video to any of a variety of heterogeneous clients. The hardware and software configuration of those clients can drive details of how video is received, processed, and rendered. For example, as discussed next, hardware acceleration may or may not be available, and multithread processing may or may not be available.

In one embodiment a client has only a software-based (CPU) single-thread decoder. In this case, the client is able to decode one slice at a time. Although slices are decoded in serial fashion, it is possible, depending on the encoding scheme used, to decode slices out of order. That is, if an encoded slice arrives at the client out of order (e.g., the second slice of a frame arrives first), the decoder may nonetheless decode slice.

FIG. 9 shows a client with a software-based multi-threaded decoder 135. The decoder 135 receives the encoded frame portions 122, perhaps out of order. Each time a new encoded frame portion is received, the decoder starts a new thread 260. Assuming that there are no dependencies between the encoded frame portions, each thread decodes its frame portion and passes the decoded slice to the renderer 137.

In another client embodiment, a combination of software (CPU) and hardware (GPU) perform decoding. Part of the decoding is performed by the CPU, which might be singly or multiply threaded. And, part of the decoding, such as motion compensation or blocking, can be done in parallel by a shader executing on the GPU. This approach can require synchronization between the CPU and the GPU to allow them to cooperate. Part of the decoding can occur in random order to reduce latency, but another other part has to be serialized with a sync point between the CPU and the GPU.

In yet another embodiment, the graphics pipeline can be implemented primarily in hardware, with possibly the CPU providing notifications of frame boundaries. This embodiment is similar to the CPU-based multi-threaded embodiment. The increased performance may cause the overall client-side latency to depend more on network conditions than the client's ability to demultiplex, decode, and render.

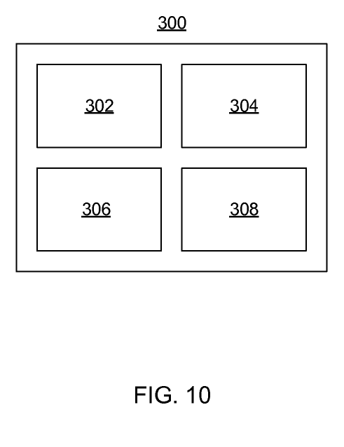

FIG. 10 shows an example of a computing device 300. One or more such computing devices are configurable to implement embodiments described above. The computing device 300 comprises storage hardware 302, processing hardware 304, networking hardware 306 (e.g. network interfaces, cellular networking hardware, etc.). The processing hardware 304 can be a general purpose processor, a graphics processor, and/or other types of processors. The storage hardware can be one or more of a variety of forms, such as optical storage (e.g., compact-disk read-only memory (CD-ROM)), magnetic media, flash read-only memory (ROM), volatile memory, non-volatile memory, or other hardware that stores digital information in a way that is readily consumable by the processing hardware 304. The computing device 300 may also have a display 308, and one or more input devices (not shown) for users to interact with the computing device 300.

The embodiments described above can be implemented by information in the storage hardware 302, the information in the form of machine executable instructions (e.g., compiled executable binary code), source code, bytecode, or any other information that can be used to enable or configure the processing hardware to perform the various embodiments described above. The details provided above will suffice to enable practitioners of the invention to write source code corresponding to the embodiments, which can be compiled/translated and executed.

1. A computing device comprising:
processing hardware, storage hardware, and a network interface configured to receive packets containing multimedia container portions comprising encoded slices of a video frame, the packets received via a network from a host that encoded the encoded slices and that generated the container portions;
a demultiplexer configured to demultiplex the encoded slices of the video frame from the container portions; and
a decoder configured to receive and decompress the encoded slices of the video frame from the demultliplexer, wherein the decoder receives a demultiplexed encoded slice of the video frame from the demultiplexer before another encoded slice of the video frame has been demultiplexed by the demultiplexer.

2. A computing device according to claim 1, wherein the demultiplexer is configured to demultiplex the other encoded slice of the video frame while the decoder is decompressing the encoded slice of the video frame.

3. A computing device according to claim 2, wherein the computing device further comprises a renderer, wherein the renderer stores a second decompressed slice of the video frame from the decoder while the decoder is decompressing the encoded slice of the video frame and while the demultiplexer is demultiplexing the other encoded slice of the video frame.

4. A computing device according to claim 3, wherein the renderer is configured to render to a display a third decompressed slice of the video frame from the decoder before the decoder has finished decompressing the encoded slice of the video frame.

5. A computing device according to claim 1, wherein the decoder outputs the decompressed slice of the video frame to a renderer before decompressing the other decoded slice of the video frame.

6. A computing device according to claim 1, wherein the demultiplexer is configured to demultiplex the other encoded slice of the video frame before receiving a second encoded slice of the video frame.

7. A computing device according to claim 6, wherein the decoder implements a video decompression algorithm that performs both inter-frame and intra-frame decoding of video frame slices.

8. A method, performed by a computing device, to perform concurrent decoding and demultiplexing of video frames, the method comprising:
at a given time, concurrently:
decoding, by a video decoder module, a first portion of a video frame, wherein the video frame is part of a video stream being received from a remote device via a network; and
receiving, via the network, a second portion of the video frame, wherein the decoding of the first portion of the video frame begins before the second portion of the video frame is fully received by the computing device.

9. A method according to claim 8, wherein the video stream is received by the computing device within a video streaming container, and further comprising, at the given time, demultiplexing a third portion of the video frame from a segment of the video streaming container.

10. A method according to claim 8, wherein the decoder comprises either a software-based decoder executing on a central processing unit of the computing device, or a hardware-based decoder executing on a graphics processing unit of the computing device, or both.

11. A method according to claim 8, wherein the first portion of the video frame, after being decoded by the decoder, is stored in a framebuffer, and while the decoded first portion of the video frame is in the framebuffer the decoder is decoding the second slice of the video frame.

12. A method according to claim 11, wherein the framebuffer is connected with a display driver of the computing device to display video frames from the framebuffer.

13. A computing device comprising:
a graphics pipeline comprising a first component and a second component, the graphics pipeline configured to receive, via a network, video frames generated and transmitted by a remote computing device and to display a video stream comprised of the video frames; and
the computing device configured such that, when operating, the first component will transform a first portion of a video frame while the second component concurrently transforms a second portion of the video frame, and during the transforming of each component neither component has access to a complete copy of the video frame, the computing device further configured such that, when operating, the second component transforms the second portion of the frame before receiving the first portion of the video frame from the first component.

14. A computing device according to claim 13, wherein the first component comprises a demultiplexer and the second component comprises a video decoder.

15. A computing device according to claim 14, wherein the decoder comprises a multithreaded module that provides a new thread for each respective video frame portion to be decoded thereby, wherein a plurality of threads concurrently decode respective video frame portions.

16. A computing device according to claim 14, wherein the decoder is configured to decode portions of video frames in parallel, using either a software-based decoder, a hardware-based decoder, or both.

17. A computing device according to claim 16, wherein the hardware based decoder comprises a hardware-accelerated compute shader.

18. A computing device according to claim 13, wherein the second component comprises a decoder, and wherein portions of a given video frame are decoded according to the order by which they are received and wherein a lower portion of the given video frame is decoded before an upper portion of the given video frame is decoded.

19. A computing device according to claim 18, wherein the graphics pipeline further comprises a renderer that renders video frames to a display, wherein the given video frame consists of a sequence of ordered portions, and wherein the renderer, accumulates and renders the portions of the given video frame.

20. A computing device according to claim 19, wherein renderer, when it receives a portion of the given video frame, determines whether the portion is a next in order after a last portion of the given video frame rendered by the renderer, wherein if the portion is determined to not be next in order then it is stored but not rendered until a portion between the last portion and the received portion has been received.
